(19) United States
(12) Patent Application Publication
(10) Pub. No.: US 2004/0233556 A1
(43) Pub. Date: Nov. 25, 2004

(54) Hunter's mirror with extension and rotation features

(75) Inventor: James A. LaViola, East Stroudsburg, PA (US)

Correspondence Address: Kenneth P. Glynn, Esq., Glynn & Associates, P.C., 24 Mine Street, Flemington, NJ, 08822, US

(73) Assignee: Hindsight Hunting Mirror, LLC

(21) Appl. No.: 10/438,424

(22) Filed: May 15, 2003

(51) Int. Cl. G02B 7/182

(52) U.S. Cl. 359/872

(57) ABSTRACT

The present invention relates to a rearward viewing mirror device that enables a user, such as a hunter, a law enforcement officer, an inspector, etc. to extend the mirror device as desired and to rotate the mirror position relative to a shaft, as desired. The present invention device includes an elongated shaft, having a proximal end and a distal end for supporting a mirror holding mechanism for holding at least one mirror. The elongated shaft has a plurality of movable segments, preferably telescopic segments, connected to one another for extending and contracting movement relative to one another. Alternatively to telescopic movement, is a plurality of hinged segments connected to one another for jack-knife like foldability. There is at least one mirror and a mirror holding mechanism for retaining and supporting the mirror(s). The mirror holding mechanism is located at a distal end of the elongated shaft and connected to the mirror(s) so as to position the mirror(s) in substantially perpendicular arrangement to the elongated shaft, and to allow a user to rotate the mirror(s) relative to the shaft. This is achieved by the mirror holding mechanism being rotatably connected to at least one of the elongated shaft and the mirror(s), that is, it is rotatabley connected to either the shaft or the mirror(s). It is preferably rotatably connected to the elongated shaft, to permit rotation of the mirror(s). The shaft, in turn, may be rotatably reconnected to a handle or to a base.

### BACKGROUND OF THE INVENTION

1. Field of the Invention

The present invention relates generally to apparatus providing rear and side vision for hunters without the need for the hunter to move in order to view what is either behind or aside, or above or below, the hunter while oriented in a given direction. The invention includes extension and rotation features to permit the user to extend the mirror to a device length of extension and to position the mirror by rotation. In some embodiments present invention combines with the apparatus for providing views in one or more directions a wind gauge so that the hunter can instantaneously determine wind direction by viewing the apparatus.

2. Information Disclosure Statement

The following patents represent various mirror or other apparatus used, for example, by hunters.

U.S. Pat. No. 4,004,850 describes a portable mirror for use in hunting includes a tripod base having individually adjustable legs for adapting to various terrain configurations. A central vertical post is mounted on the tripod and supports a pair of articulating mirrors. The mirrors are individually rotatably adjustable about the longitudinal axis of the post. The mirrors are vertically slidable along the post relative to the ground.

U.S. Pat. No. 4,856,888 describes an adjustable telescoping mirror disclosed which may be secured to a surface such as a wall or mirror secured to a wall. The adjustable mirror includes a base having four suction cups arranged in two rows which are parallel to the ground when the base is secured to the wall. A telescoping rod is secured to the base by a first coupling which is located below the suction cups when the base is secured to the wall. The mirror is secured to the other end of the telescoping rod by a second coupling. The couplings, have sufficient friction to support the weight of the mirror when it is extended and placed in a desired location, but do not prevent the user from easily moving the mirror as desired. The two rows of suction cups, and their locations above the first coupling, resist forces created by the mirror when it is extended which tend to pull the mirror away from the wall. The location of the first coupling is close to the lower edge of the base so that the device is compact when contracted and folded.

U.S. Pat. No. 5,186,118 describes a wind gauge that includes silica dispensed from their container as a floating cloud which is carried along by ambient wind and thus illustrates wind speed and direction. The particulate media may also include a mixture of silica particles and thermoplastic color-pigmented particles, so that the floating cloud is colored and thus more easily visible. The particles may also embody a scent and be used to form a scent trail as they are carried along by the wind and as they gradually settle out of the air.

U.S. Pat. No. 5,291,778 describes an indicator member that is arranged for mounting to a barrel portion of a hunting rifle or to an interior surface of a hunting archery bow to include a boss mounting a filament, wherein the filament indicates wind orientation preventing hunter positioning to be exposed by downwind orientation of game. A hollow supporting boss is arranged to secure the filament and may be further provided with an interior spool to permit projection of the filament therefrom from a magazine support roll.

U.S. Pat. No. 5,383,061 describes a rearview mirror apparatus for use by hunters while seated in a tree stand facing a tree trunk, includes a mirror attached to mounting arm assembly having a spike for removably penetrating the trunk for selective mounting thereto and demounting therefrom in a viewing position forwardly of the tree stand seat to provide a hunter with a reflected rearward field of view from a stationary seated position facing the tree trunk. Preferably, the arm assembly includes a jointed arm portion providing at least one ball-and-socket joint by which the viewing field of the mirror may be selectively adjusted.

U.S. Pat. No. 5,400,183 describes a simple portable rearview mirror apparatus for hunters which can be used on the ground or above the ground being attached to a tree or other object. The apparatus which can be made of wood, plastic, or metal includes a hollow rectangular box frame having opposing side walls attached to a back wall and a top wall. A reflective mirror is hingedly attached at its bottom end within the frame interior to the lower interior of the side walls and is slidably mounted at its top end within opposing swivel slot arched shaped openings provided on the upper side walls surface. The mirror moves back and forth by means of attachments riding within the swivel opening s to give a upper and lower view of the background. The apparatus is used at ground level by being supported by a rod inserted into the ground which is secured to a locking element releasably attached to the back wall. A fastening cord which is looped through the apparatus allows it to be tied to an object above the ground such as a tree.

U.S. Pat. No. 5,943,175 describes a combination rearward viewing and wind gauge comprising a base member having a plurality of mounting holes and being comfortable to the shape of a substantially rigid underlying support surface, an elongated shaft for supporting a holder at least one mirror and flexible line for determining wind direction and movement, the elongated shaft being perpendicular to an outer facing surface of the base member and attached to the base member and to the holder for the at least one mirror being attached to the elongated shaft at its distal end. The elongated shaft is bendable over its entire length to selected positions with the capability to remain in said selected positions. The combination also includes a flexible hinge conjoining adjacent sections of the mirror holder with each section containing a mirror and being separately angularly adjustable such that the sections may be selectively positioned to align each of the faces of the mirrors in a relative angular displacement which varies over the range of 0° to 180°. The flexible line has a weight and size so as to be displaceable from its rest position by air movement showing said air movement by the direction and displacement.

U.S. Pat. No. 6,220,717 describes a rear view mirror device for use with an elevated hunter platform is disclosed. The device includes a frame member retaining a mirror element on a front side. A back side of the frame member includes a rod receiving portion for receiving and retaining a top end of a flexible rod. A bottom end of the flexible rod attaches by a screw and wing nut to a center portion of a clamp. The clamp includes a pair of handles and a pair of fingers which are actuated by a spring disposed within the clamp center portion. To deploy the device, pressure is applied to the handles which opens the fingers. The device is then located to its desired position on the elevated hunter platform whereafter the pressure on the handles is released causing the fingers to engage a rail of the platform. The mirror element can then be positioned by rotating the device about a plurality of axises such that the hunter does not have to turn his head to see the area behind or to the side of his forward facing view.

Notwithstanding the prior art, the present invention is neither taught nor rendered obvious thereby.

### SUMMARY OF THE INVENTION

The present invention relates to a rearward viewing mirror device that enables a user, such as a hunter, a law enforcement officer, an inspector, etc. to extend the mirror device as desired and to rotate the mirror position relative to a shaft, as desired. The present invention device includes an elongated shaft, having a proximal end and a distal end for supporting a mirror holding means for holding at least one mirror at the distal end thereof. The elongated shaft has a plurality of movable segments, preferably telescopic segments, connected to one another for extending and contracting movement relative to one another, that is telescopic movement, or has a plurality of hinged segments connected to one another for jack-knife like foldability. There is at least one mirror and a mirror holding means for retaining and supporting the mirror(s). The mirror holding means is located at a distal end of the elongated shaft and connected to the mirror(s) so as to position the mirror(s) in substantially perpendicular arrangement to the elongated shaft, and to rotate the mirror(s) relative to the shaft. This is achieved by the mirror holding means being rotatably connected to at least one of the elongated shaft and the mirror(s), that is, it is rotatably connected to either the shaft or the mirror(s). It is preferably rotatably connected to the elongated shaft, to permit rotation of the mirror(s).

In some preferred embodiments, the present invention device further includes a base member having a plurality of mounting holes and being conformable to the shape of a substantially rigid underlying support surface. This base may also have a slot or buckle loop or other attachment means, e.g.: for wrapping a strap around a pole or tree and fastening it tightly to the base.

In other embodiments, the device further includes flexible hinge conjoining adjacent sections of the mirror holding means, each section containing a mirror and being separately angularly adjustable. The flexible hinge may be selectively positioned to align each of the faces of the mirrors in a relative angular displacement that varies over a range of 0° to 180°.

In other embodiments, the present invention device further includes a handle located at an end opposite the distal end. The handle may be an elongated handle attached to the shaft in axial alignment therewith. Further, in some embodiments, the handle may include an elongated handle section attached in axial alignment therewith and a grip section extending downwardly from said elongated handle section. Also, it may include any of the foregoing handle arrangements, and further include attachment means for attachment to an object, such as is described above, e.g. a flat base with or without holes or a strap attachment slot or loop. The mechanism used for rotating the mirror holding means relative to the shaft, and/or the shaft relative to the base, may be a conventional swivel, or it may be a ball joint for rotation of the mirror relative to the elongated shaft.

In some embodiments, the device of the present invention may also include a wind gauge means attached to the device for determining wind direction and movement.

### BRIEF DESCRIPTION OF THE DRAWINGS

For the purpose of illustrating the invention, there is shown in the drawings forms which are presently preferred, it being understood, however, that the invention is not limited to the precise arrangements and instrumentalities shown. Thus, the present invention should be more fully understood when the specification herein is taken in conjunction with the drawings appended hereto wherein:

FIG. 1 is a front plan view of a first embodiment of the rearward field of vision mirror device of the present invention showing the mirror, mirror holder and optional wind gauge;

FIG. 2 is a plan view of a universal base for one embodiment of a present invention rearward field of vision device of the present invention;

FIG. 5 shows a side view of yet another alternative embodiment present invention rear view mirror device with rigid, elongated foldable extension members;

FIG. 6 shows a side view of an alternative embodiment present invention mirror device with an axial handle;

FIG. 7 shows a partial cut side view of a present invention rear view mirror device with a handle having a grip;

FIG. 8 is a exploded side view of a rearward field of vision device of the present invention showing bi-sectional mirrors, mirror holders and wind gauge;

FIG. 8a is a top view of FIG. 8; and,

FIG. 9 shows a scenario for use of present invention devices in a hunter's environment.

### DETAILED DESCRIPTION OF THE PRESENT INVENTION

The following detailed descriptions are of the best presently contemplated modes of carrying out the invention. The description is not intended in a limiting sense, and is made solely for the purpose of illustrating the general principles of the invention.

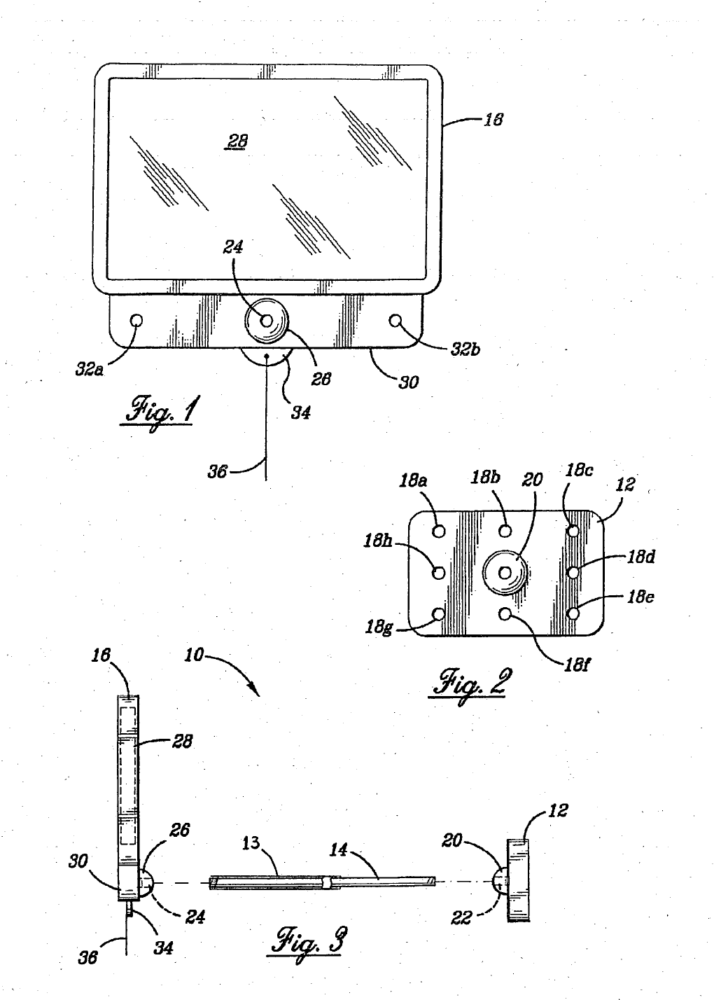

Referring now to the drawings in detail, where like numerals refer to like parts or elements, there is shown in FIGS. 1 through 3 a first embodiment of the rearward field of vision mirror device 10. The mirror device 10 is comprised of three major elements, i.e. a base 12, a telescopic extendable, elongated shaft, with members 13 and 14, and a combination mirror holder 16.

With particular reference to FIGS. 2 and 3, the base 12 has a number of mounting holes 18a through 18h arrayed symmetrically for securing the base 12 to a rigid support. Located at the center of the base 12 is a universal joint shaft holder support 20 having a central axially aligned opening 22 extending into the support 20 to provide rotation of member 14 relative to the base 12. Use of the mounting holes 18a through 18h of the base 12 will be described in greater detail hereinafter.

The extendable elongated shaft 14 may have a preferred length varying from approximately 12″ to approximately 30″ so that the combination mirror holder 16, which is attached to its distal end, is positioned at a distance of between 1 foot and 2½ feet away from the support to which the base 12 is attached. Longer or shorter lengths may be utilized, depending upon the intended use and compactness desired. In some cases, a sufficient number of extension segments may be used to render the device pocket size, or belt attachable, or hammer loop size. For example, it may be desired to accommodate a police officer, soldier, border patrol officer or customs inspector uniforms or needs.

As shown in FIG. 3, proximal end of the arm or shaft 14 is inserted into the opening 22 of the universal joint shaft holder support 20. The extendable, elongated shaft 14 may have diameters of between 0.25″ and 0.375″ and may be made of a material which is thin enough to achieve ease of movement for selected positions for the mirror holder 16, yet sufficiently strong as to maintain the desired position selected by the user. Further, the shaft 14 may be inserted into an opening 24 in a universal joint shaft holder support 26 similar in size and dimension to universal joint shaft holder support 20. These connections may be screw (threaded) connections, snap in connections, welds, or any other available manner of connection, as long as devised notability is not hindered.

The cross-sectional configuration of the shaft 14, while preferred to be circular, may also be square or rectangular, or any other shape, so long as the capability of being extended as desired and intended. In embodiments where the extension is achieved telescopically, the shaft segments are hallow. In other present invention embodiments, the shaft segments may be fold ups and hence flat cross-sections are preferred.

Housed within the mirror holder 16 is a mirror 28 which may be press fitted into the mirror holder 16 or mounted into the mirror holder 16 by other means known in the art or later discovered. The mirror 28 may have a flat, planar surface or curvilinear surface. As can best be seen in FIGS. 1 and 2, the mirror 28 is held in position by the frontally extended framing and retaining lip of the mirror holder 16 surrounding and encompassing the mirror 28. The mirror holder 16 has a downwardly depending flange 30 which is formed along with, and may be considered a rigid portion of, the mirror holder 16. It could alternatively be located on the top or side or corner of mirror holder 16. Mounted to the depending flange 30 is the shaft holder and support 26 previously described. At opposite sides of the depending flange 30 are alternate mounting holes 32a, and 32b, such that, if desired, the user may affix a combination mirror directly to a support by the use of ties, bungi cords, etc.

Depending downward from the flange 30 is optional depending thin, arcuate protrusion or tab 34 positioned at the midpoint of the width and depth dimensions of the depending flange 30. Secured to and hanging downward from the optional tab 34 is a flexible line 36 which, in combination with the optional tab 34, forms the wind gauge of the present invention. The line 36 is secured to the tab 34 at a point slightly inward from the edge thereof such that the remaining length of flexible line 36 is permitted to swing freely as to be immediately displaced by any movement of the surrounding air. The flexible line 36 has a weight and size so as to be displaceable from its rest position by any air movement. This displacement will show air movement and direction by the direction of the displacement. The line 36 may be formed from absorbent material and contain a scent to camouflage the scent of the hunter or to introduce another scent into the immediate surrounding area. The scent may be applied by means of absorbing a liquid or a spray of a desired scent in liquid form.

FIG. 4 shows a side view of an alternative embodiment present invention device 40. It includes an elongated shaft of three interconnected telescopic hollow segments at the proximal end (to the right) is a universal ball joint connector 57 attached to segment 55 and base 59. This universal joint arrangement permits left and right rotations as well as up and down rotation of base 59 relative to shaft 50. Not that base 59 has screw holes for attachment to a receptive object, but also has a loop 58 for receiving a strap or belt or other flexible attachment. This could be used around a metal object.

At the distal end of shaft 50 (the left side of the figure) attachment 47 is connected to ball joint 45, which is connected to mirror holding means 41 having mirror 43. Again, because of the universal ball joint connection, mirror 43 and mirror holding means 41 may be rotated to the left or to the right or up or down or otherwise relative to shaft 50.

FIG. 5 shows a side view of another present invention alternative embodiment device 60. It has a mirror holder 61 with mirror 63, connected to a vertical axis rotation cup 65 which is hingidly connected to segment 67 via a rivet 66 with a horizontal axis of rotation. Segment 67 is connected via rivet 73 to segment 69. Likewise, segment 69 is hingidly connected to segment 71 via rivet 75. Segment 71 is connected to base 77 via rotation wheel 83. Attachment orifices 79 and 81 are included on base 77. Rotations of the base and the mirror relative to shaft 50 may be achieved similarly to that ascribed to that of FIG. 4 above. The present invention device 60 is extended and compacted by folding of the segments in a jack-knife like manor similar to folding rulers.

FIG. 6 shows a side view of yet another present invention devise 80 with telescopic segments 84, 85, and 86. At the proximal end of segment 86 is handle 87 with grip 88. At the distal end of segment 84 is universal ball joint 83 connected to mirror holder 81 with mirror 82. Holder 81 with mirror 82 may be rotated 360 degrees, tilted back about 80 degrees and twisted to the left or right as desired. This embodiment is particularly useful for inspection and for looking around corners to avoid collisions or getting shot or otherwise. Under vehicle inspections for motor vehicle personnel or customs or homeland security are included among many other diverse uses.

FIG. 7 shows a partial side view of another present invention embodiment that would have a mirror, mirror holder and a ball joint arrangement as shown in FIG. 6. Here, device 90 including telescopic segments 91 and 93 with handle 95 having a right angle hand grip 97.

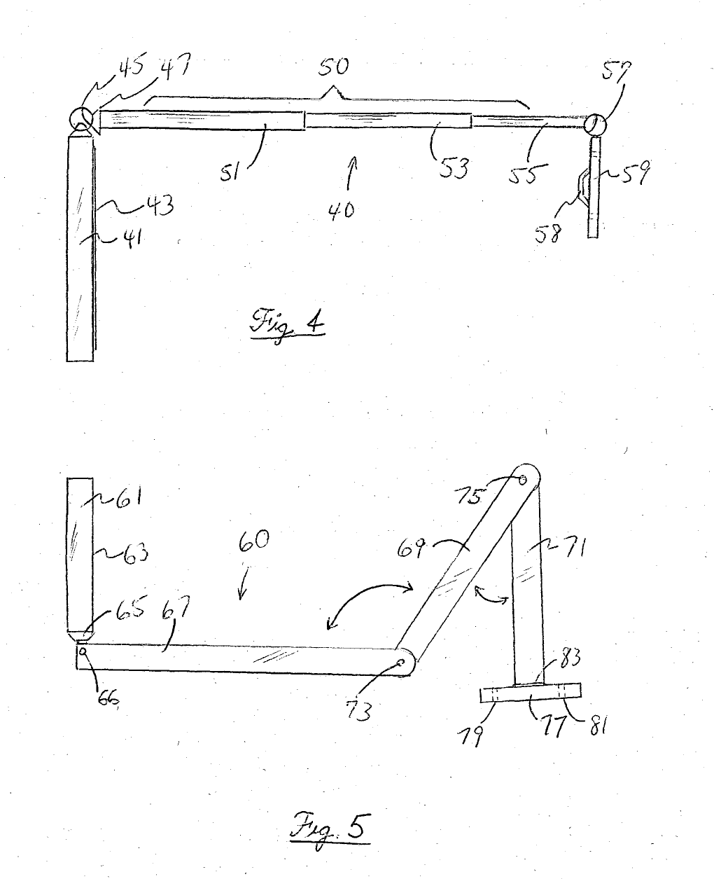

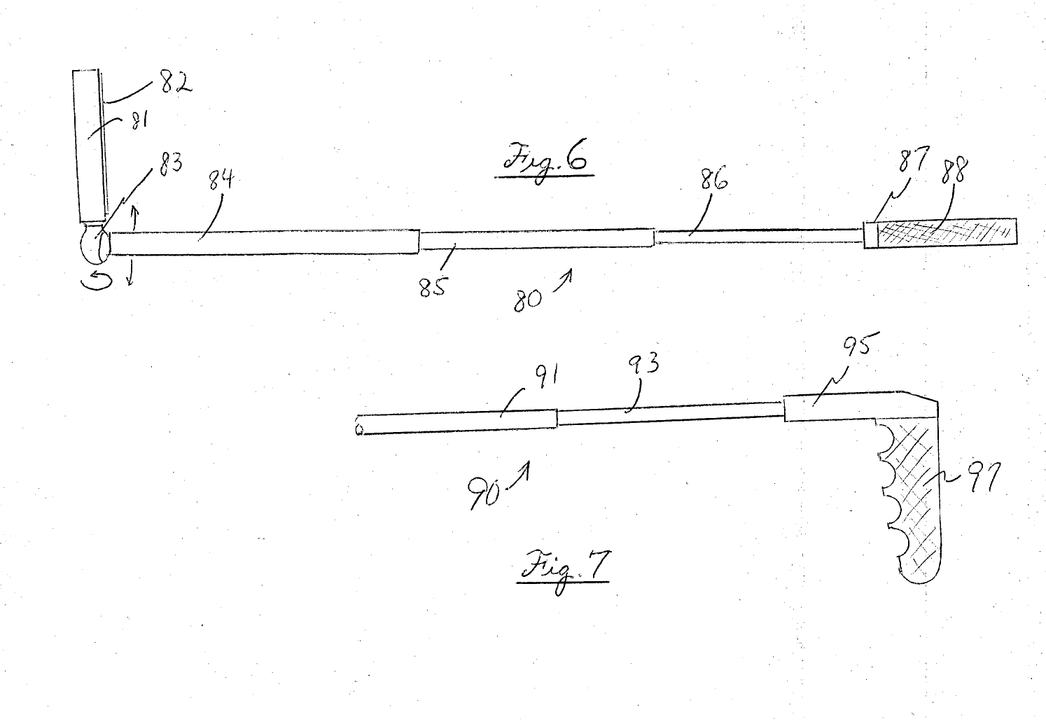

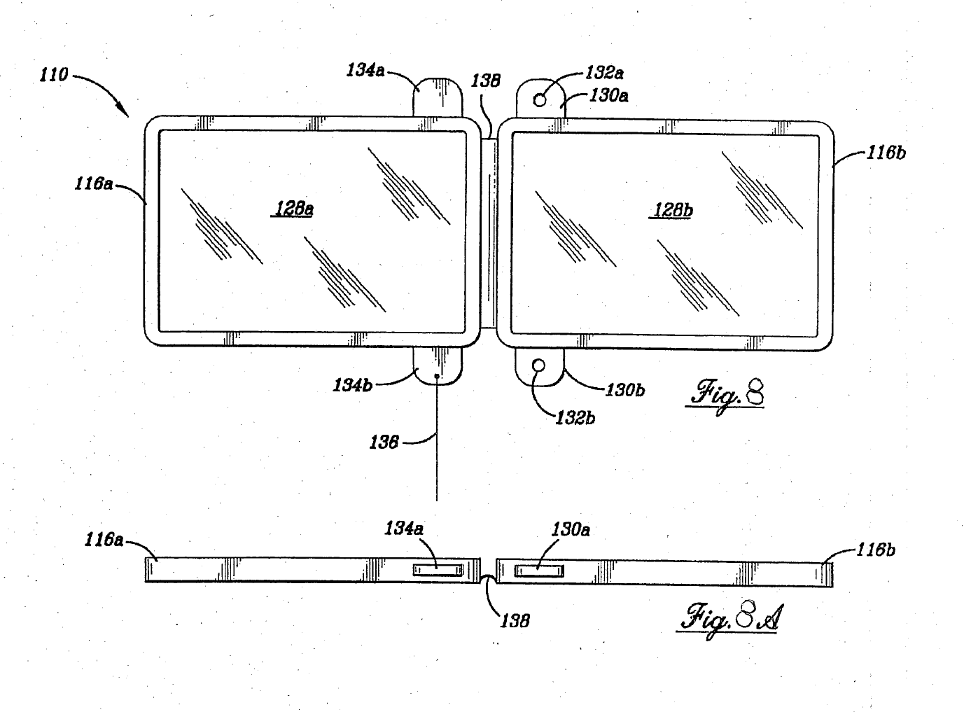

Another embodiment of the present invention is shown in FIGS. 8 and 8a and may be generally described as a bi-sectional rearward field of vision mirror apparatus 110. Not shown in the referenced drawing figures are the base (or a handle) and elongated extension shaft, as such elements are identical to those elements described with reference to FIG. 3. However, mounting of the shaft to the combination bisection mirror holder 116 may be the same as described above, or alternatively may be slightly different than earlier described.

The combination mirror holder 116 is bi-sected into left and right sections 116a, 116b, respectively. The two mirrors 128a, 128b are disposed within a framing and retaining lip of each of the combination mirror holder sections 116a, 116b in similar fashion to that described in connection with the first embodiment of the present invention. Attached to the right section 116b are two flanges or tabs 130a, 130b which are positioned along the top and the bottom edges of the mirror holders, respectively. The tabs 130a, b located proximate to the left side of the right section 116b, each having a mounting hole 132a, 132b extending respectively therethrough. As each of the tabs 130a, 130b has a depth or thickness (as shown in FIG. 8a), the shaft, when inserted, fits snugly against the surrounding portions of the mounting holes 132a, 132b as described above. However, in connection with the second embodiment, either of the mounting holes 132a, 132b, may be used depending upon the desired positioning of the mirror apparatus 110 by the hunter.

The left section 116a has tabs 134a, 134b positioned proximate to the right edge of the mirror holder and of similar size to the tabs 130a, 130b of the right section of mirror holder 116b. However, tab 134a, has no mounting holes and serves merely as a weight balancing element so that the symmetry of the overall mirror apparatus remains intact. The tab 134b serves a similar function to the protrusion or tab 34 in the first embodiment by providing a point from which is flexible wind gauge line 136 may be secured. The line 136 serves the same purpose as the previously described flexible line 36 in connection with the first embodiment by providing the user with an immediate response to any air motion displacing the line 136 away from its at rest position. While this has been described as useful for hunters, it could also be beneficial to snipers and other law enforcement and military personnel.

Connecting the right and left sections 116a, 116b of the mirror apparatus 110 is a flexible, positionable hinge 138 which extends from a position proximate to the top edge of each of the sections to a position proximate to the bottom edge of each of the sections 116a, 116b of the mirror apparatus 110. This “living” hinge, is formed of a flexible plastic (or similar plasticized polymer) and conjoins each of the sections, 116a, 116b if the mirror apparatus 110. The hinge 138 is sufficiently pliable yet exhibits material memory so that when flexed to a desired position, it will substantially maintain that position until further adjustment by the hunter. In FIG. 4a, the “living” hinge 138 has been flexed so that the mirror holder sections 116a, 116b are aligned in a straight line, but other positions are possible which are either greater or lesser than 180° position shown in the drawing figure. Of course, other hinge types may be used to achieve the same purpose, e.g. snap-hinge with ball and concave receivers, pin-hinge, etc., all made from similar plastic materials as is the materials as is the mirror holder 116a, 116b.

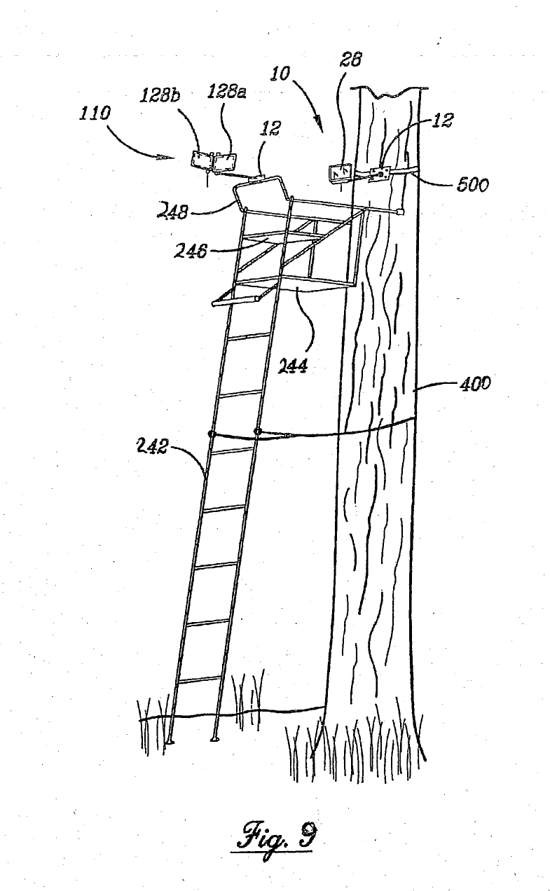

With reference to FIG. 9, both of the embodiments of the present invention are shown as they could be when one possible actual use scenario. The first embodiment of the rearward field of vision mirror apparatus 10 is shown attached about a vertical cylindrical object, a tree 400, just above the elevated platform 244 of a hunter's tree stand 242. The mirror 28 of the rearward field of vision apparatus 10 extends outward, downward and to the left of the tree stand platform and seat 246, a sufficient distance away from the tree so that the hunter when seated in the tree stand seat 246, facing away from the tree 400, can shift his eyes to the left and view a field of vision behind and to the left of the tree 400.

The base of the rearward field of vision apparatus 10 can be secured about the tree 400 by ties, bungi cords, and the like, by utilizing the mounting holes 18a, 18c, 18e and 18g, shown more clearly in FIG. 2. Temporarily mounting the base as described securely maintains the base in direct contact with the surface of the tree 400 in the desired position selected by the hunter with little chance of self-repositioning. The securing of the base 12 about the tree 400 has been described using two ties or bungi cords, or like securing means 500, for securing the rearward field of vision apparatus 10 to the tree 400. The base 12 may also have channels on its underside through which straps may be placed to secure the base to a support surface in like manner.

Up to this point, the base 12, which is substantially rectangular in shape, has been described as being secured with the large dimension of the rectangle in a horizontal orientation. It is also possible to orient the base with the larger dimension in a vertical orientation and secure it in place using the same corner mounting holes, 18a, 18c, 18e and 18g. Additionally, it is possible to secure the base 12 to the upstanding object or support surface by using the central mounting holes 18d and 18h for a horizontal orientation or 18b and 18f for a vertical orientation. Likewise, it is possible to secure the base 12 to the upstanding object or support surface using opposite corner mounting holes and a single securing tie, bungi cord, or like securing means 500.

Alternately, the base 12 is mountable to a differently formed surface such as rail 248 of the tree stand as shown in FIG. 5. In the instance of mounting, the base has its larger dimension in the horizontal direction and ties would extend between corner mounting holes 18a and 18g and corner mounting holes 18c and 18e to secure the base in a relatively fixed position against the tree stand rail 248.

The bi-sectional mirror holder 116 is positioned outward from the tree stand rail 248 at the end of the elongate arm with the flexible hinge 138 positioned such that the sections 116a, 116b are not in alignment so that the relative angular displacement between the mirror 128a, 128b is greater than 0°. The respective mirrors 128a, 128b provide rearward and sideward fields of vision directly to the right of the tree 400 and also further to the right of the tree 400, with the field of vision of the angled mirror 128b being farther outward from the tree proportionate to the difference in angular relationship between the planar surfaces of each of the mirrors 128a, 128b. In this fashion, the hunter can, with little or no motion (or even movement of the head), see a significant area to the rear and to the right rear side while sitting with his back to the obstructional vertical or upstanding object the tree 400. It is also possible with either or both of the embodiments of the present invention to rotate and position the extendable elongated arm 14 so that the rearward field of vision may be also focused upward or downward (or right or left) of the seated position of the hunter and the respective mirror position.

In some preferred embodiments, the base 12 may be constructed from a thermoplastic elastomer and will conform substantially to the shape of the underlying support surface. It should also be understood that the base 12 may be constructed in different sizes and with varying dimensions so that mounting against different support surfaces is made easier.

In connection with embodiments of the present invention, the wind gauge which depends downward from the combination mirror holder 16, 116 provides a substantially immediate and continues indication of air movement and direction so that the hunter is aware of the wind direction so that he can make the determination of whether the game being sought is upwind or downwind of his position. An alternate type indicator of air movement which can be used in a pinwheel type rotating detector which will show motion, but not necessarily direction, of the air movement. Although, both types are contemplated for use with the present invention, thee multi-purpose line 36, 136 is preferred.

Thus, with the combination of the adjustable rearward field of vision mirror apparatus 10, 110 and the wind gauge, a hunter can virtually remain motionless yet still continually monitor a significantly increased field of vision. The present embodiments of the invention may be used in other similar environments such as a tree blind, a ground blind, or merely be used in connection with a stool or seat positioned near or against an upstanding object to which the combination rear viewing apparatus may be secured.

The present invention may be and clearly is useful for activities other than hunting. Nature and wildlife photographers also use a variety of and stands while they await the arrival of certain selected animals, birds, etc. so that photographs of the subjects may be taken. The photographer needs to remain just as motionless as a hunter so that indeed subject of the photograph is unaware of the presence of the photographer and is not scared away by any quick motion on the part of the photographer. Likewise, law enforcement officers, military personnel, G-men, FBI, interpol, customs and many other officials may use the present invention device in many diverse activities, e.g. inspecting, spying, sniping, entering around blinds, etc.

What is claimed is:

1. A rearward viewing mirror device, which comprises:
(a) an elongated shaft having a proximal end a distal end, for supporting a mirror holding means for holding at least one mirror at said distal end thereof, said elongated shaft having a plurality of telescopic segments connected to one another for telescopic movement relative to one another;
(b) said at least one mirror attached to said mirror holding means at said distal end of said elongated shaft; and,
(c) said mirror holding means for retaining and supporting said at least one mirror, said means being located at said distal end of said elongated shaft and connected to said at least one mirror so as to position said at least one mirror in substantially perpendicular arrangement to said elongated shaft, said mirror holding means being rotatably connected to at least one of said elongated shaft and said at least one mirror, to permit rotation of said at least one mirror relative to said elongated shaft.

2. The device of claim 1 wherein said device further includes a base member having a plurality of mounting holes and being conformable to the shape of a substantially rigid underlying support surface, said base member being rotatably connected to said elongated shaft at its proximal end.

3. The device of claim 1, wherein said device further includes at least one flexible hinge conjoining adjacent sections of said mirror holding means, each said section containing a mirror and being separately angularly adjustable.

4. The device of claim 3, wherein said at least one flexible hinge may be selectively positioned to align each of the faces of the mirrors in a relative angular displacement that varies over a range of 0° to 180°.

5. The device of claim 1, wherein said device further includes a handle located at said proximal end.

6. The device of claim 5 wherein said handle is an elongated handle attached to said shaft in axial alignment therewith.

7. The device of claim 5, wherein said handle includes an elongated handle section attached in axial alignment therewith and a grip section extending downwardly from said elongated handle section.

8. The device of claim 5 wherein said handle further includes attachment means for attachment to an object.

9. The device of claim 1, wherein said elongated shaft has three telescopic segments.

10. The device of claim 1 wherein said mirror holding means includes a ball joint for rotation of said mirror relative to said elongated shaft.

11. The device of claim 1 further including wind gauge means attached to said device for determining wind direction and movement.

12. A rearward viewing mirror device, which comprises:
(a) an elongated shaft having a proximal end and a distal end for supporting a mirror holding means for holding at least one mirror at said distal end thereof, said elongated shaft having a plurality of segments connected to one another for extension and retraction movement relative to one another;
(b) said at least one mirror attached to said mirror holding means at said distal end of said elongated shaft; and,
(c) said mirror holding means for retaining and supporting said at least one mirror, said means being located at said distal end of said elongated shaft and connected to said at least one mirror so as to position said at least one mirror in substantially perpendicular arrangement to said elongated shaft, said mirror holding means being rotatably connected to at least one of said elongated shaft and said at least one mirror, to permit rotation of said at least one mirror relative to said elongated shaft.

13. The device of claim 12 wherein said segments are connected to one another end-to-end at pivot points to enable jack-knife foldability thereof.

14. The device of claim 12 wherein said device further includes a base member having a plurality of mounting holes and being conformable to the shape of a substantially rigid underlying support surface.

15. The device of claim 13 wherein said device further includes a base member having a plurality of mounting holes and being conformable to the shape of a substantially rigid underlying support surface.

16. The device of claim 11, wherein said device further includes at least one flexible hinge conjoining adjacent sections of said mirror holding means, each said section containing a mirror and being separately angularly adjustable.

17. The device of claim 16, wherein said at least one flexible hinge may be selectively positioned to align each of the faces of the mirrors in a relative angular displacement that varies over a range of 0° to 180°.

18. The device of claim 13 wherein there are at least three connected segments.

19. The device of claim 18, wherein said device further includes a handle located at said proximal end of said elongated shaft.

20. The device of claim 12 further including a handle located at said proximal end of said elongated shaft.
